(19) United States
(12) Patent Application Publication
(10) Pub. No.: US 2014/0008154 A1
(43) Pub. Date: Jan. 9, 2014

(54) ELEVATOR TENSION MEMBER

(71) Applicants: John P. Wesson, Vernon, CT (US); Gopal R. Krishnan, Wethersfield, CT (US); Daniel Rush, Canton, CT (US); Vijay Jayachandran, West Hartford, CT (US)

(72) Inventors: John P. Wesson, Vernon, CT (US); Gopal R. Krishnan, Wethersfield, CT (US); Daniel Rush, Canton, CT (US); Vijay Jayachandran, West Hartford, CT (US)

(73) Assignee: OTIS ELEVATOR COMPANY, Farmington, CT (US)

(21) Appl. No.: 14/006,440

(22) PCT Filed: Mar. 21, 2011
(86) PCT No.: PCT/US2011/029183

§ 371 Date: Sep. 20, 2013

(51) Int. Cl. B66B 7/06; B66B 11/00

(52) U.S. Cl. CPC B66B 7/062; B66B 11/008
USPC 187/254; 428/394; 428/395; 428/376

(57) ABSTRACT

A belt for suspending or driving an elevator car includes a plurality of wires arranged into one or more cords; and a jacket substantially retaining the one or more cords. At least one of the one or more cords includes a plurality of non-load bearing filler filaments interposed between adjacent wires of the plurality of wires. An elevator system includes an elevator car, one or more sheaves, and one or more belts operably connected to the car and interactive with the one or more sheaves for suspending or driving the elevator car. Each belt of the one or more belts includes a plurality of wires arranged into one or more cords and a jacket substantially retaining the one or more cords. At least one of the one or more cords includes a plurality of non-load bearing filler filaments interposed between adjacent wires of the plurality of wires.

### BACKGROUND OF THE INVENTION

The subject matter disclosed herein relates to tension members such as those used in elevator systems for suspension and/or driving of the elevator car and/or counterweight.

Tension members for elevators typically include a one or more cords formed from a plurality of steel wires arranged in a geometrically stable configuration. Depending on wire diameters, only a certain number of geometrically stable arrangements are possible. Cords are often arranged into a belt which comprises a plurality of such cords at least partially enclosed in an elastomeric jacket material. In the belt construction, interaction between the steel cord material and the individual cord wires with the jacket material is the primary basis of cord to jacket adhesion and bonding, unless an additional adhesive is used. Relatively small steel wires also known as “fill wires” can be added in the cord construction to fill gaps in the cord construction and allow the cord structure to be “opened” allowing for better flow of the jacket material thereinto thus promoting increased jacket to cord adhesion.

Addition of small diameter steel fill wires adds additional manufacturing steps with a corresponding increase in cost. Further, steel fill wires increase stiffness of the cord which results in higher bending stress and decreased cord life.

### BRIEF DESCRIPTION OF THE INVENTION

According to one aspect of the invention, a belt for suspending and/or driving an elevator car includes a plurality of wires arranged into one or more cords; and a jacket substantially retaining the one or more cords. At least one of the one or more cords includes a plurality of non-load bearing filler filaments interposed between adjacent wires of the plurality of wires.

Alternatively in this or other aspects of the invention, at least some of the plurality of wires are arranged in a plurality of strands, and the plurality of strands are arranged into the one or more cords.

Alternatively in this or other aspects of the invention, at least some of the plurality of non-load bearing filler filaments are located at an outer periphery of at least one cord of the one or more cords.

Alternatively in this or other aspects of the invention, at least some of the plurality of wires are arranged in a center strand located substantially at a center of a cord of the one or more cords.

Alternatively in this or other aspects of the invention, at least some of the plurality of non-load bearing filler filaments are located substantially abutting the center strand.

Alternatively in this or other aspects of the invention, at least some of the plurality of non-load bearing filler filaments are arranged to form a center strand located substantially at a center of a cord of the one or more cords.

Alternatively in this or other aspects of the invention, the plurality of non-load bearing filler filaments are formed from an organic fiber or yarn.

Alternatively in this or other aspects of the invention, the organic fiber or yarn is of a polyamide material.

Alternatively in this or other aspects of the invention, a melting or softening temperature of the plurality of filler filaments is lower than a melt temperature of the jacket.

According to another aspect of the invention, an elevator system includes an elevator car, one or more sheaves, and one or more belts operably connected to the car and interactive with the one or more sheaves for suspending and/or driving the elevator car. Each belt of the one or more belts includes a plurality of wires arranged into one or more cords and a jacket substantially retaining the one or more cords. At least one of the one or more cords includes a plurality of non-load bearing filler filaments interposed between adjacent wires of the plurality of wires.

According to yet another aspect of the invention, a cord for use in an elevator suspending and/or driving belt, includes a plurality of wires arranged into one or more strands and a plurality of non-load bearing filler filaments interposed between adjacent wires of the plurality of wires.

### BRIEF DESCRIPTION OF THE DRAWINGS

FIG. 1A is a schematic of an exemplary elevator system having a 1:1 roping arrangement;

FIG. 1B is a schematic of another exemplary elevator system having a different roping arrangement;

FIG. 1C is a schematic of another exemplary elevator system having a cantilevered arrangement;

FIG. 2 is a cross-sectional view of an exemplary elevator belt;

FIG. 3 is a cross-sectional view of a prior art cord for an elevator belt;

FIG. 4 is a cross-sectional view of an embodiment of a cord for an elevator belt;

FIG. 5 is a cross-sectional view of another embodiment of a cord for an elevator belt;

FIG. 6 is a cross-sectional view of another embodiment of a cord for an elevator belt;

FIG. 7 is a cross-sectional view of another embodiment of a cord for an elevator belt;

FIG. 8 is a cross-sectional view of another embodiment of a cord for an elevator belt;

FIG. 9 is a cross-sectional view of another embodiment of a cord for an elevator belt;

FIG. 10 is a cross-sectional view of another embodiment of a cord for an elevator belt; and

FIG. 11 is a cross-sectional view of another embodiment of a cord for an elevator belt.

FIG. 12 is a cross-sectional view of another embodiment of a cord for an elevator belt.

The detailed description explains the invention, together with advantages and features, by way of examples with reference to the drawings.

### DETAILED DESCRIPTION OF THE INVENTION

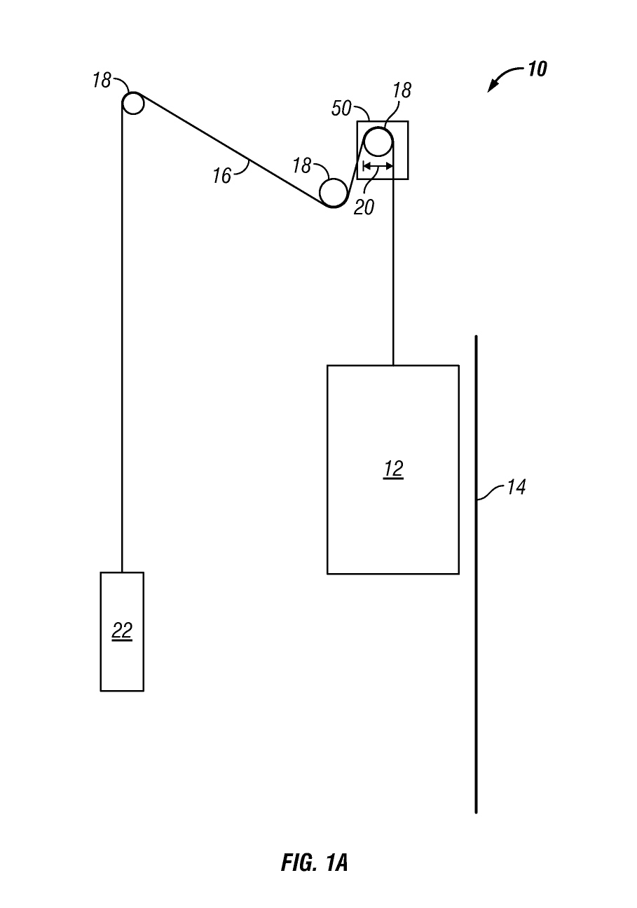

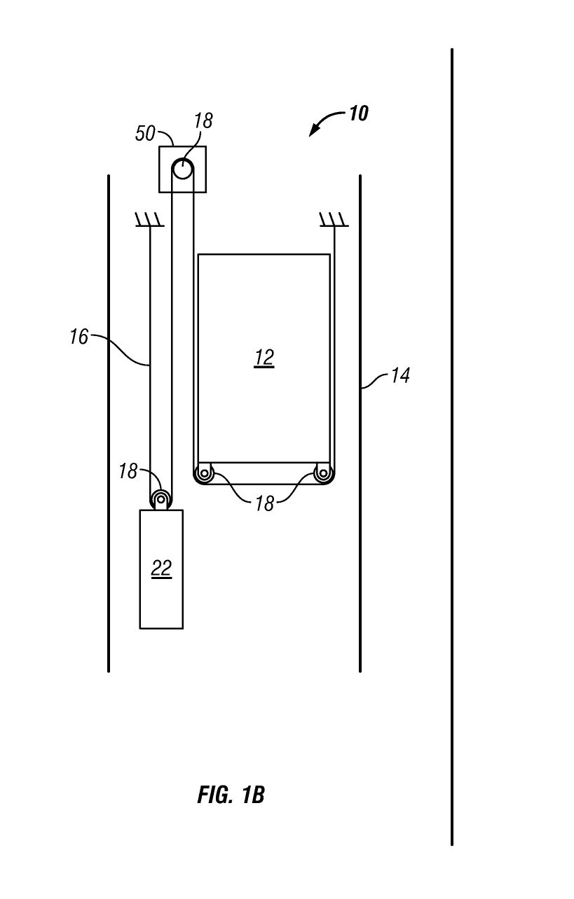

Shown in FIGS. 1A, 1B and 1C are schematics of exemplary traction elevator systems 10. Features of the elevator system 10 that are not required for an understanding of the present invention (such as the guide rails, safeties, etc.) are not discussed herein. The elevator system 10 includes an elevator car 12 operatively suspended or supported in a hoistway 14 with one or more belts 16. The one or more belts 16 interact with one or more sheaves 18 to be routed around various components of the elevator system 10. The one or more belts 16 could also be connected to a counterweight 22, which is used to help balance the elevator system 10 and reduce the difference in belt tension on both sides of the traction sheave during operation.

The sheaves 18 each have a diameter 20, which may be the same or different than the diameters of the other sheaves 18 in the elevator system 10. At least one of the sheaves 18 could be a drive sheave. A drive sheave is driven by a machine 50. Movement of drive sheave by the machine 50 drives, moves and/or propels (through traction) the one or more belts 16 that are routed around the drive sheave.

At least one of the sheaves 18 could be a diverter, deflector or idler sheave. Diverter, deflector or idler sheaves are not driven by a machine 50, but help guide the one or more belts 16 around the various components of the elevator system 10.

In some embodiments, the elevator system 10 could use two or more belts 16 for suspending and/or driving the elevator car 12. In addition, the elevator system 10 could have various configurations such that either both sides of the one or more belts 16 engage the one or more sheaves 18 (such as shown in the exemplary elevator systems in FIGS. 1A, 1B or 1C) or only one side of the one or more belts 16 engages the one or more sheaves 18.

FIG. 1A provides a 1:1 roping arrangement in which the one or more belts 16 terminate at the car 12 and counterweight 22. FIGS. 1B and 1C provide different roping arrangements. Specifically, FIGS. 1B and 1C show that the car 12 and/or the counterweight 22 can have one or more sheaves 18 thereon engaging the one or more belts 16 and the one or more belts 16 can terminate elsewhere, typically at a structure within the hoistway 14 (such as for a machineroomless elevator system) or within the machine room (for elevator systems utilizing a machine room. The number of sheaves 18 used in the arrangement determines the specific roping ratio (e.g. the 2:1 roping ratio shown in FIGS. 1B and 1C or a different ratio). FIG. 1C also provides a so-called rucksack or cantilevered type elevator. The present invention could be used on elevator systems other than the exemplary types shown in FIGS. 1A, 1B and 1C.

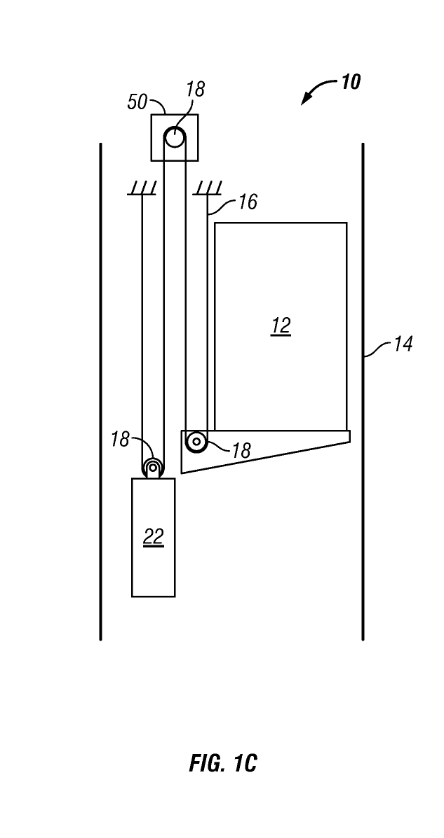

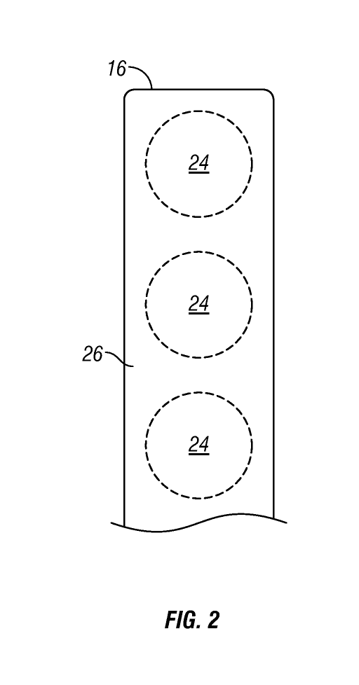

FIG. 2 provides a schematic of an exemplary belt construction or design. Each belt 16 is constructed of one or more cords 24 in a jacket 26. The cords 24 of the belt 16 could all be identical, or some or all of the cords 24 used in the belt 16 could be different than the other cords 24. For example, one or more of the cords 24 could have a different construction or size than the other cords 24. As seen in FIG. 2, the belt 16 has an aspect ratio greater than one (i.e. belt width is greater than belt thickness).

The belts 16 are constructed to have sufficient flexibility when passing over the one or more sheaves 18 to provide low bending stresses, meet belt life requirements and have smooth operation, while being sufficiently strong to be capable of meeting strength requirements for suspending and/or driving the elevator car 12.

The jacket 26 could be any suitable material, including a single material, multiple materials, two or more layers using the same or dissimilar materials, and/or a film. In one arrangement, the jacket 26 could be a polymer, such as an elastomer, applied to the cords 24 using, for example, an extrusion or a mold wheel process. In another arrangement, the jacket 26 could be a woven fabric that engages and/or integrates the cords 24. As an additional arrangement, the jacket 26 could be one or more of the previously mentioned alternatives in combination.

The jacket 26 can substantially retain the cords 24 therein. The phrase substantially retain means that the jacket 26 has sufficient engagement with the cords 24 such that the cords 24 do not pull out of, detach from, and/or cut through the jacket 26 during the application on the belt 16 of a load that can be encountered during use in an elevator system 10 with, potentially, an additional factor of safety. In other words, the cords 24 remain at their original positions relative to the jacket 26 during use in an elevator system 10. The jacket 26 could completely envelop the cords 24 (such as shown in FIG. 2), substantially envelop the cords 24, or at least partially envelop the cords 24

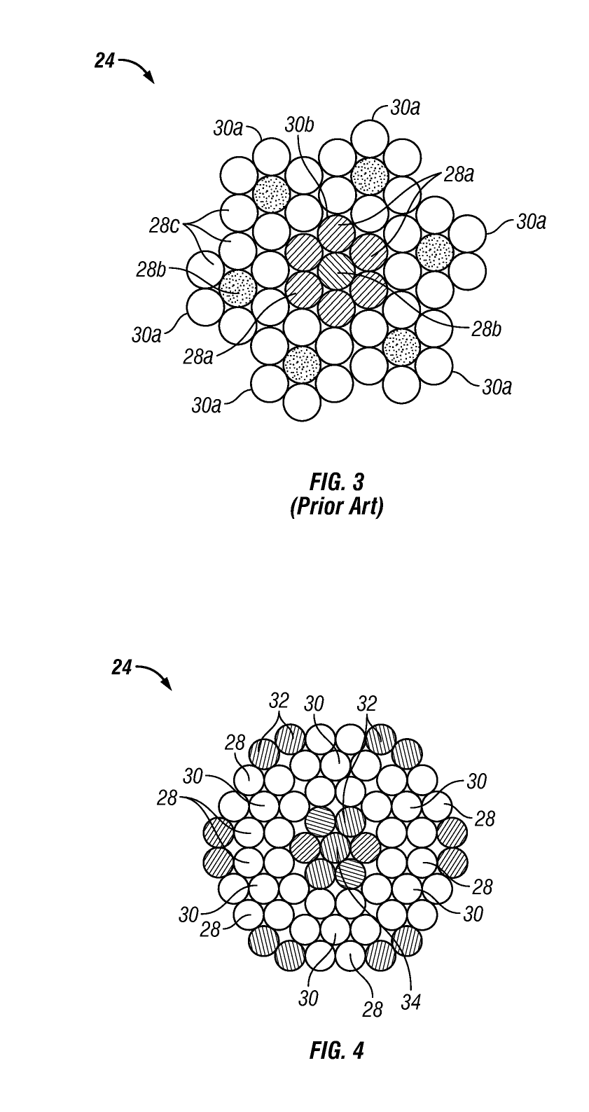

Referring now to FIG. 3, each cord 24 comprises a plurality of wires 28 in a geometrically stable arrangement. The wires 28 are formed from steel or other load-carrying material. The steel wires 28 provide the tensile strength of the cord 24 and determine the bending stress of the cord 24 which, in turn, determines the cord 24 life. Optionally, some or all of these wires 28 could be formed into strands 30, which are then formed into the cord 24. The phrase geometrically stable arrangement means that the wires 28 (and if used, strands 30) generally remain at their theoretical positions in the cord 24. In other words, movement of the wires 28 (and if used, strands 30) relative to each other is limited. For example, relative movement of wire 28 could be limited to less than approximately thirty percent (30%) of its diameter. Relative movement of strand 30 could be limited to less than approximately five percent (5%) of its diameter.

Shown in FIG. 4 is an exemplary embodiment of a cord 24. In the embodiment of FIG. 4, the cord 24 further comprises a plurality of filler filaments 32. The filler filaments 32 are non load-carrying elements of the cord 24 and may be formed from organic fibers or yarn of, for example, nylon (polyamide) polyester materials. The filler filaments 32 can each be composed of a monofilament (single fiber), a continuous multifilament (multiple fibers) or a yarn spun from a multiplicity of discontinuous fibers. The filler filaments 32 are configured and located in the cord 24 to be non-load carrying. The filler filaments 32 are arranged in the cord 24 to open and stabilize the cord 24 structure. By “open”, it is meant that the inclusion of the filler elements 32 increases a spacing between two or more wires 28 in the cord 24. The opening of the cord 24 structure promotes increased penetration of elastomeric jacket 26 (shown in FIG. 2) material into the cord 24 to improve adhesion between the cord 24 and the jacket 26 material. Further, filler filaments 32 of organic fibers or yarn form stronger bonds with the elastomer jacket 26 material than does steel, further improving adhesion between cord 24 and jacket 26 over the prior art. Moreover, inclusion of the filler filaments 32 in the cord 24 reduces wear of the cord 24 due to fretting.

Specifically, the cord 24 embodiment of FIG. 4 includes six strands 30, each including seven wires 28 arranged around a center 34 comprising a plurality of filler filaments 32, in this embodiment seven filler filaments 32. Further, additional filler filaments 32 are arranged between adjacent strands 30 at, for example, a periphery of the cord 24.

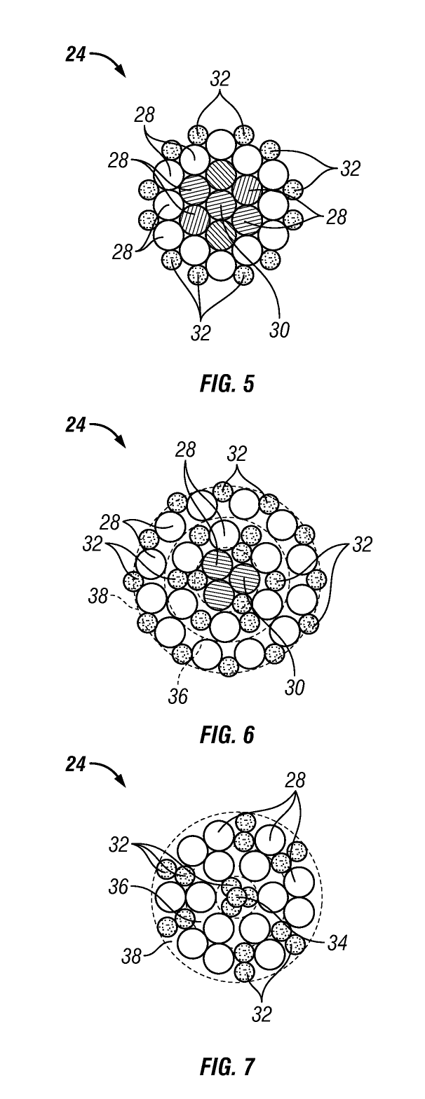

FIG. 5 illustrates another exemplary embodiment of a cord 24. In this embodiment, twelve outer wires 28 are arranged around a center strand 30 having seven wires 28. Filler filaments 32 are arranged between the outer wires 28 substantially at the periphery of the cord 24.

Another exemplary embodiment is shown in FIG. 6. This embodiment includes a center strand 30 having three wires 28. The center strand 30 is surrounded by an inner ring 36 comprising six wires 28. The inner ring 36 is in turn surrounded by an outer ring 38 having twelve wires 28. Filler filaments 32 are located between the center strand 30 and the inner ring 36. Further, additional filler filaments 32 are located between the wires 28 of the inner ring 36 and the wires 28 of the outer ring 38. In some embodiments, additional filler filaments 32 are arranged between wires 28 of the outer ring 38 at the periphery of the cord 24.

Yet another exemplary embodiment of a cord 24 is shown in FIG. 7. The embodiment of FIG. 7 includes a center 34 including three filler filaments 32. The center 34 is surrounded by inner ring 36 having five wires 28 which is, in turn, surrounded by outer ring 38 having nine wires 28. Additional filler filaments 32 are located between adjacent wires 28 of the outer ring 38, between wires 28 of the inner ring 36 and between the inner ring 36 and outer ring 38.

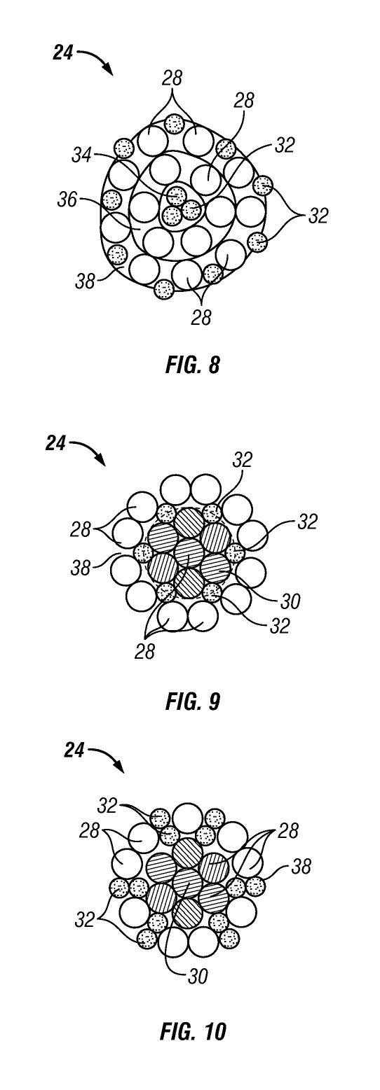

Referring now to FIG. 8, in some embodiments the center 34 is surrounded by an inner ring 36 having six wires 28 which is, in turn, surrounded by an outer ring 38 having nine wires 28. In such embodiments, additional filler filaments 32 are located between adjacent wires 28 of the outer ring 38 substantially at the periphery of the cord 24.

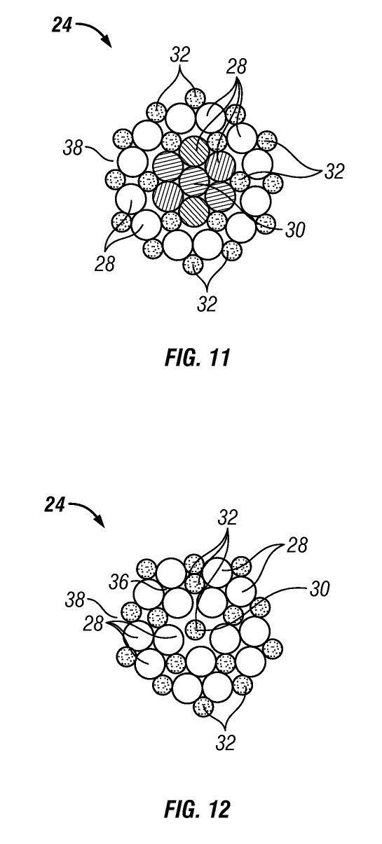

FIGS. 9-11 illustrate embodiments of a cord 24 having a center strand 30 comprising six wires 28 surrounding a center wire 28. The embodiment of FIG. 9 includes a filament ring 40 including six filler filaments 32 surrounding the center strand 30, and an outer ring 38 of twelve wires 28 surrounding the filament ring 40. In the embodiment of FIG. 10, the center strand 30 is surrounded by an outer ring 38 having nine wires 28. The filler filaments 32 are disposed substantially between adjacent wires 28 of the outer ring 38, and in some embodiments as shown, with pairs (or more than two) filler filaments 32 located between adjacent wires 28. The embodiment of FIG. 11 includes an outer ring of twelve wires 28 surrounding the center strand 30. Filler filaments 32 are arranged between the center strand 30 and the outer ring 38 and also between adjacent wires 28 of the outer ring 38 at the periphery of the cord 24.

Another exemplary embodiment is shown in FIG. 12. This embodiment includes a center strand 30 comprising one or more filler filaments 32. An inner ring 36 surrounding the center strand 30 has five wires 28. An outer ring 38 substantially surrounds the inner ring 36 and includes ten wires 28. A plurality of filler filaments 32, in the embodiment shown, five filler filaments 32, are located between the inner and outer rings 36 and 38. Further, ten filler filaments 32 are located between adjacent wires 28 of the outer ring 38 at the periphery of the cord 24.

In additional embodiments of the cord 24, the filler filaments 32 are configured to have a melting or softening temperature which is lower than the melting temperature of the elastomeric jacket 26 material. Thus during manufacturing to encase the cord 24 in the jacket 2 material, the filler elements 32 soften or melt to increase flow of the jacket 26 material throughout the cord 24 and result in better adhesion of the jacket 26 material to the cord 24.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A belt for suspending and/or driving an elevator car, comprising:
a plurality of wires arranged into one or more cords; and
a jacket substantially retaining the one or more cords;
wherein at least one of the one or more cords includes a plurality of non-load bearing filler filaments interposed between adjacent wires of the plurality of wires.

2. The belt of claim 1, wherein at least some of the plurality of wires are arranged in a plurality of strands, and the plurality of strands are arranged into the one or more cords.

3. The belt of claim 1, wherein at least some of the plurality of non-load bearing filler filaments are disposed at an outer periphery of at least one cord of the one or more cords.

4. The belt of claim 1, wherein at least some of the plurality of wires are arranged in a center strand disposed substantially at a center of a cord of the one or more cords.

5. The belt of claim 4, wherein at least some of the plurality of non-load bearing filler filaments are disposed substantially abutting the center strand.

6. The belt of claim 1 wherein at least some of the plurality of non-load bearing filler filaments are arranged to form a center strand disposed substantially at a center of a cord of the one or more cords.

7. The belt of claim 1, wherein the plurality of non-load bearing filler filaments are formed from an organic fiber or yarn.

8. The belt of claim 7, wherein the organic fiber or yarn is of a polyamide material.

9. The belt of claim 1, wherein the plurality of non-load bearing filler filaments are formed from a single organic fiber, a multifilament fiber or yarn composed of discontinuous fibers spun into a filament.

10. The belt of claim 1, wherein a melting or softening temperature of the plurality of filler filaments is lower than a melt temperature of the jacket.

11. An elevator system comprising:
an elevator car;
one or more sheaves; and
one or more belts operably connected to the car and interactive with the one or more sheaves for suspending and/or driving the elevator car, each belt of the one or more belts including:
a plurality of wires arranged into one or more cords; and
a jacket substantially retaining the one or more cords;
wherein at least one of the one or more cords includes a plurality of non-load bearing filler filaments interposed between adjacent wires of the plurality of wires.

12. The elevator system of claim 11, wherein at least some of the plurality of wires are arranged in a plurality of strands, and the plurality of strands are arranged into the one or more cords.

13. The elevator system of claim 11, wherein at least some of the plurality of non-load bearing filler filaments are disposed at an outer periphery of at least one cord of the one or more cords.

14. The elevator system of claim 11, wherein at least some of the plurality of wires are arranged in a center strand disposed substantially at a center of a cord of the one or more cords.

15. The elevator system of claim 14, wherein at least some of the plurality of non-load bearing filler filaments are disposed substantially abutting the center strand.

16. The elevator system of claim 11, wherein at least some of the plurality of non-load bearing filler filaments are arranged to form a center strand disposed substantially at a center of a cord of the one or more cords.

17. The elevator system of claim 11, wherein the plurality of non-load bearing filler filaments are formed from an organic fiber or yarn.

18. The elevator system of claim 11, wherein the organic fiber or yarn is of a polyamide material.

19. The elevator system of claim 11, wherein a melting or softening temperature of the plurality of filler filaments is lower than a melt temperature of the jacket.

20. A cord for use in an elevator suspending and/or driving belt, comprising:
a plurality of wires arranged into one or more strands; and
a plurality of non-load bearing filler filaments interposed between adjacent wires of the plurality of wires.

21. The cord of claim 20, wherein at least some of the plurality of non-load bearing filler filaments are disposed at an outer periphery of the cord.

22. The cord of claim 20, wherein at least some of the plurality of wires are arranged in a center strand disposed substantially at a center of the cord.

23. The cord of claim 22, wherein at least some of the plurality of non-load bearing filler filaments are disposed substantially abutting the center strand.

24. The cord of claim 20 wherein at least some of the plurality of non-load bearing filler filaments are arranged to form a center strand disposed substantially at a center of the cord.

25. The cord of claim 20, wherein the plurality of non-load bearing filler filaments are formed from an organic fiber or yarn.

26. The cord of claim 25, wherein the organic fiber or yarn is of a polyamide material.
